(19) United States
(12) Patent Application Publication
(10) Pub. No.: US 2009/0284666 A1
(43) Pub. Date: Nov. 19, 2009

(54) DUAL-LINE CHIP DESIGN OF LIGHT MODULATOR

(75) Inventor: Benny Svardal, Bergen (NO)

Correspondence Address: KNOBBE MARTENS OLSON & BEAR LLP, 2040 MAIN STREET, FOURTEENTH FLOOR, IRVINE, CA, 92614, US

(73) Assignee: POLIGHT AS, Horten (NO)

(21) Appl. No.: 12/331,343

(22) Filed: Dec. 9, 2008

Related U.S. Application Data
(63) Continuation of application No. 12/106,987, filed on Apr. 21, 2008, now abandoned.
Application No. 12/106,987 is a continuation of application No. PCT/NO2006/000362, filed on Oct. 18, 2006.

(30) Foreign Application Priority Data
Oct. 19, 2005 (NO) 20054838

(51) Int. Cl. H04N 9/31

(52) U.S. Cl. 348/744; 348/E09.025

(57) ABSTRACT

Doubling the resolution of images in a line scan projection system is possible without doubling the length of the modulator or changing the size of the pixels. By arranging an additional pixel row in the modulator, and merging the rows together with half a pixel offset in both directions in the projected image, the resolution may be effectively doubled without significantly increasing the size or speed requirement for the modulator itself.

### RELATED APPLICATIONS

This application is a continuation of U.S. application Ser. No. 12/106,987, titled “Dual-Line Chip Design of Light Modulator,” filed Apr. 21, 2008, which is a continuation of PCT/NO2006/000362, filed Oct. 18, 2006, which was published in English and designated the U.S., and claims priority to NO 20054838 filed Oct. 19, 2005, each of which are incorporated herein by reference.

### BACKGROUND

1. Field

The field is related to scanning line color display systems, and particularly to a modulator device for use in a single path color projection system comprising a first array of pixels providing a 1^{st} line to be displayed and a second additional array of pixels arranged on the modulator substrate shifted vertically ½ pixel relative to said first array of pixels, and which is time shifted with the 1^{st} line to achieve 2D pixel shift in the projected image.

2. Description of the Related Technology

Projection display systems have recently become increasingly popular for a multiple of applications, ranging from e.g., rear projection consumer TV's to front projector products for presentation purposes. Several different light modulator technologies exist for projection displays, and the light modulator is currently typically based on Digital Micro mirror device (DMD), Liquid Crystal on Silicon (LCOS) or Liquid Crystal Display (LCD) technology. Several new technologies have also recently been proposed, based on one-dimensional light modulator arrays for line scanning projection using laser illumination, e.g., Grating Light Valve (GLV), Grating Electromechanically System (GEMS), and DxP.

There is a trend towards higher resolution in the display market, driven by e.g., demand for larger screen sizes and new high definition TV standards. Common to all projection technologies is that higher resolution increases both component and system cost, since the required modulator size increases, as well as the demand requires better performance of the light modulator in form of e.g., response speed and uniformity.

Some of the current projection systems in prior art utilize a high-speed scanning (projection) system in the optical chain to achieve a half-pixel shift on the screen in order to increase resolution without increasing actual pixel count on the display itself. Examples of this technique are products from HP using Texas Instruments HD3 DMD.

In a projector like this, for each frame of image data received, multiple sub-frames of data are generated. Each sub-frame contains unique image information, and is projected onto the screen in a slightly different position by means of an opto-mechanical image shifter. This causes pixels from distinct sub-frames to overlap with pixels from original frame resulting in an increased resolution. The light modulator in such prior art systems must have a switching speed fast enough to support the sub-frame display rate. Sub-frames are projected in rapid succession similar to individual frames in a movie creating a continuous flicker-free image. FIG. 1 is an illustration of such increasing pixel resolution. An image of a sub-frame, 1, is generated by projecting a 2D display modulator onto the screen. Subsequently, an image of a second sub-frame, 2, is generated the same way, but the image is shifted ½ pixels on the screen. The resulting image, 3, has a higher resolution than the individual sub-frames as well as the display modulator.

GB 475,971 A discloses a light vent for television use. The light vent is based on a diffractive element, wherein the diffraction can be changed by using electromechanical, for example piezo element, wherein a staggered pattern can be achieved.

US 2005/0078056 A discloses a display system with a color wheel wherein frames can be shifted ½ pixel relative to each other.

EP 0 606 136 A discloses a micromechanical light modulator for use in a printing system. An arrangement of micro mirrors provide a shift between lines of half a frame.

### SUMMARY OF CERTAIN INVENTIVE ASPECTS

According to one aspect, the same effect of doubling the resolution as with the prior art solutions may be achieved, but without the increased response speed requirement and moving parts in the system. The proposed idea is to make an additional array of pixels on the modulator, shifted vertically ½ pixel, and time shifted with the 1^{st} line to achieve 2D pixel shift in the scanned image. Since these two pixel lines (arrays) can be addressed separately and synchronized with an offset in accordance with the line scanning speed, the solution do not require increased response speed. Embodiments effectively reduce the required modulator size in the pixel line (array) direction by at least two.

Compared to current “wobulated” scan techniques in e.g., DMD projectors, the present invention also reduces time sequential artifacts seen in certain moving images.

For line scan projectors, a single pixel row may be imaged directly or indirectly onto the viewing screen, and projected with a rotating mirror to achieve 2D image.

In order to increase the pixel resolution of such a device, it is possible either to scale down the pixel size or increase the length of the modulator pixel array. According to an aspect an additional pixel array (line) adjacent to the original pixel (array) line on the modulator substrate that is shifted ½ pixel in the direction of the pixel array provides an increase in resolution of images. When an outgoing light beam from each pixel array passes through the optical system, they intersect in the Fourier plane where the undesired diffraction orders are filtered out. This plane is subsequently imaged with toroidal optics onto the screen, i.e., focused in the scan direction only. Hence, an overlapping image is provided in the scan direction on the screen for both the original pixel array and the adjacent additional pixel array such that the additional pixel array is shifted in the array direction by the same ½ pixel offset as provided on the modulator substrate. In addition, when projecting a line to get a 2D image, electronic control may time the addressing of the two pixel arrays with an offset, and hence we can shift the images from the two rows on the screen by e.g. ½ pixel also in the scan (projection) direction.

In an embodiment, a light modulator comprising two adjacent pixel rows shifted ½ pixels as described above comprise in addition a delay element providing a time delay between input signals to the two adjacent pixel rows, respectively.

According to an aspect, image processing algorithms may be used to analyze content of images to be displayed and provide correct shifted image information to be modulated by the two adjacent pixel arrays in the modulator. An Image Signal Processor (ISP) may execute such algorithms as known to a person skilled in the art. According to an embodiment, an ISP unit controls the modulation in the modulator with correct time shifted signals as described above.

### BRIEF DESCRIPTION OF THE DRAWINGS

FIG. 1 illustrates a method to increase resolution.

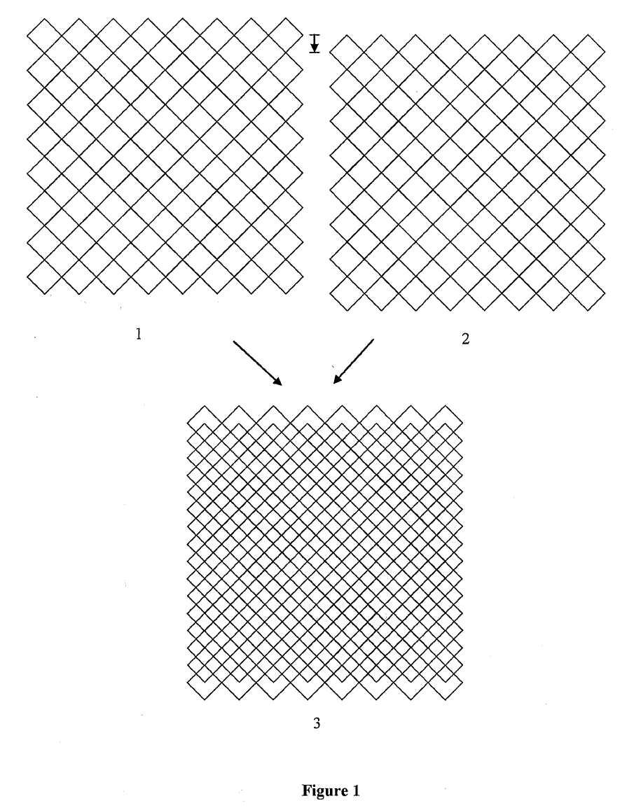

FIG. 2 depicts an embodiment of a method to increase resolution.

FIG. 3 depicts an example of an embodiment of a system.

FIG. 4 is a block diagram illustrating an example of an embodiment comprising an image display system.

FIG. 5 is an illustration of the resulting increased resolution of an image using an embodiment.

### DETAILED DESCRIPTION OF CERTAIN INVENTIVE EMBODIMENTS

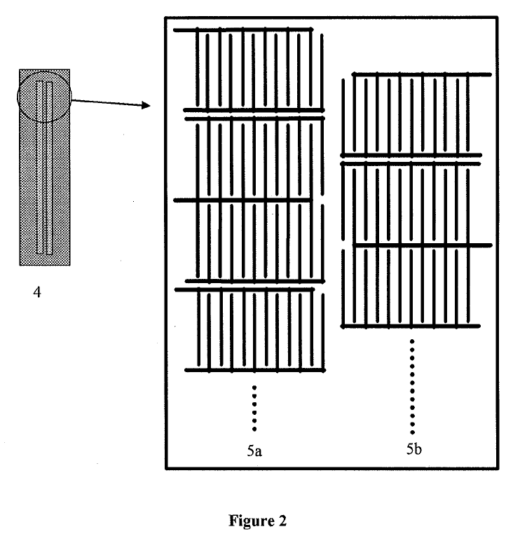

FIG. 2 is an illustration of an example of an embodiment. The modulator chip, 4, has two parallel rows of individual pixels. The enlarged view shows that there is an offset of ½ pixel between the two modulator rows, 5a and 5b.

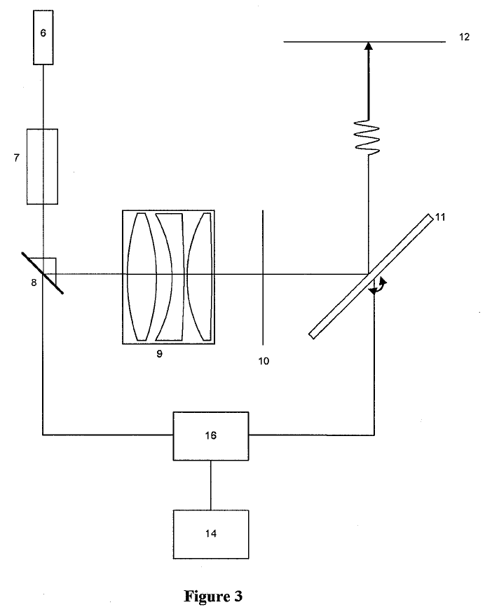

FIG. 3 is an illustration of an embodiment used in a projection system. A light source, 6, directs light through a system of source optics, 7 onto a light modulator, 8. Projection optics, 9, images the modulator rows through a filter plane, 10, which removes unwanted diffraction orders, onto a single line on the screen and a scanning device, 11, scans (projects) the line across the screen creating a 2D image, 12.

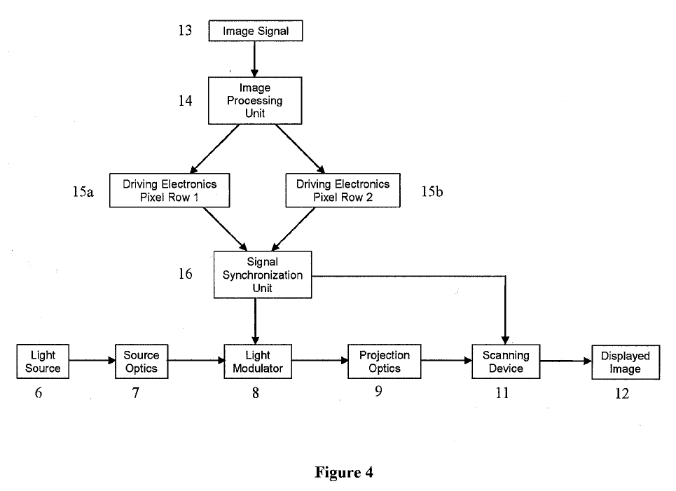

FIG. 4 is a block diagram illustrating an embodiment of an image display system with increased resolution. A light source, 6, directs light through a system of source optics, 7 onto a light modulator, 8. The modulation is achieved via, for example, an image signal, 13, processed through an image processing unit ISP, 14, which processes the image and directs control signals to two driving electronic units, one for each pixel row in the modulator, 15a and 15b, respectively.

The driving electronic signals are processed through a synchronization unit, 16, which ensures that there is a time delay corresponding to ½ pixel in the scan direction between the activation of the two pixel rows. Projection optics, 9, images the modulator rows onto a single line on the screen and a scanning device, 11, scans the line across the screen creating a 2D image, 12.

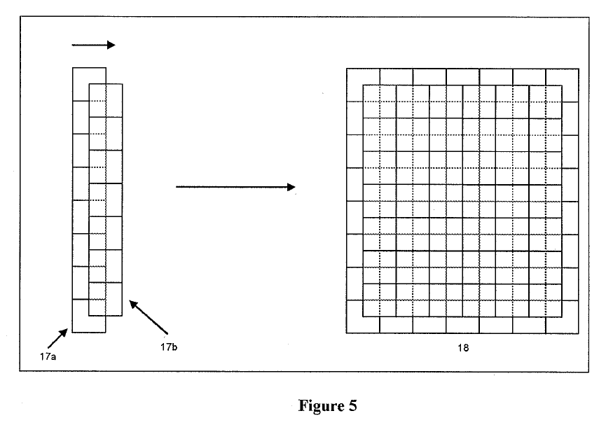

FIG. 5 is an illustration of how the system creates increased resolution in the projected image. The pixels in the first modulator pixel row, 17a, are physically displaced by ½ pixel in one direction with respect to the pixels in the second pixel row, 17b. Furthermore, they are temporally displaced by ½ pixel in a direction orthogonal to the first direction with the aid of said driving electronics. When the line image is scanned across the screen to generate a 2D image, 18, the result is an image with twice the resolution as compared to an image using a single-line modulator.

The embodiments presented have twice the number of pixels as a single-line modulator of the same length with the same pixel size such that the increased resolution results. The generated image is a superposition of two images, one from each pixel row. Accordingly, the requirements on the response speed of the modulator are the same as for a single-line modulator generating an image with half the number of pixels in the scan direction. Also, in some embodiments, since the length of a dual-line modulator is half the length of a single-line modulator with the same pixel size, smaller and cheaper projection optics can be used for image generation.

While the above detailed description has shown, described, and pointed out novel aspects as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. A method for displaying an image in a line scan projector system, wherein the method comprises:
processing images to be projected in the projector system to generate image information for two adjacent pixel rows such that the image information is a superposition of two images, one image corresponding to each of the two pixel rows, wherein the processing comprises delaying the information for one of the pixel rows relative to the other of the pixel rows;
applying the image information to a light modulator comprising two adjacent pixel rows on a substrate, wherein one of the pixel rows is shifted about ½ pixel in the direction of the row, relative to the other row.

2. The method of claim 1, wherein the amount of time of delaying the information for one of the pixel rows relative to the other of the pixel rows corresponds to about one half the time for displaying a single pixel.

3. A line scan projection system comprising a light source configured to transmit light through system source optics onto a light modulator configured to receive an image signal, wherein the light modulator comprises two adjacent pixel rows such that one of the pixel rows is shifted ½ pixel relative to the other of the two pixel rows in the direction of the shifted row.

4. The system of claim 3, further comprising an processing unit configured to process images to be projected in the projector system to generate image information for the two pixel rows such that the image information is a superposition of two images, one image for each of the two pixel rows, wherein the processing comprises delaying the information for one of the pixel rows relative to the other of the pixel rows.

5. The system of claim 4, wherein the processing unit is configured to apply the image information to the light modulator.

6. The system of claim 3, further comprising a synchronization unit configured to insert a time delay between the control signals communicated from the processing unit to the two pixel rows.

7. A light modulator, comprising:
two adjacent pixel rows, wherein one of the pixels rows is shifted about ½ pixel in the direction of the shifted row relative to the other of the two pixel rows; and
a delay element configured to provide a time delay between input signals for each of the two adjacent pixel rows, respectively.
